(19) United States
(12) Patent Application Publication
(10) Pub. No.: US 2017/0181167 A1
(43) Pub. Date: Jun. 22, 2017

(54) LONG RANGE LOW POWER TRANSMITTER OPERATIONS

(71) Applicant: Intel IP Corporation, Santa Clara, CA (US)

(72) Inventors: Thomas Kenney, Portland, OR (US); Shahrnaz Azizi, Cupertino, CA (US)

(21) Appl. No.: 14/979,293

(22) Filed: Dec. 22, 2015

(51) Int. Cl. H04W 72/04; H04L 29/08; H04L 27/26

(52) U.S. Cl. CPC H04W 72/0453; H04L 27/2636; H04L 67/12; H04W 84/12

(57) ABSTRACT

This disclosure describes methods, apparatus, and systems related to a long-range low-power (LRLP) system. A device may identify a communication channel with a first device. The device may identify one or more user data. The device may generate an LRLP waveform based at least in part on the one or more user data, the LRLP waveform having a frequency bandwidth. The device may to pass the LRLP waveform through an M-point DFT of the device. The device may cause to send the processed LRLP waveform to the first device.

### TECHNICAL FIELD

This disclosure generally relates to systems and methods for transmitter architecture and, more particularly, to long-range low-power operations in wireless communications.

### BACKGROUND

With the advent of wireless devices, Internet of Things (IoT) devices are becoming widely prevalent in home and other environment. Communications between IoT devices may be done over long distances. A long-range low-power (LPLR) Technical Interest Group is currently being formed to investigate the feasibility of LRLP for IoT or other devices. A next generation WLAN, IEEE 802.11ax or High-Efficiency WLAN (HEW), is a Wi-Fi standard and is under development. HEW utilizes Orthogonal Frequency-Division Multiple Access (OFDMA) in channel allocation. HEW supports backward compatibility with earlier Wi-Fi standards.

### BRIEF DESCRIPTION OF THE DRAWINGS

FIG. 1 depicts a network diagram illustrating an example network environment of illustrative long-range low-power (LRLP) operations, according to one or more example embodiments of the disclosure.

FIG. 2 depicts an illustrative schematic diagram of a LRLP system, in accordance with one or more example embodiments of the present disclosure.

FIG. 3 depicts an illustrative schematic diagram of an LRLP system, in accordance with one or more example embodiments of the present disclosure.

FIG. 4 depicts a flow diagram of an illustrative process for an LRLP system, in accordance with one or more embodiments of the disclosure.

FIG. 5 illustrates a functional diagram of an example communication station that may be suitable for use as a user device, in accordance with one or more example embodiments of the disclosure.

FIG. 6 is a block diagram of an example machine upon which any of one or more techniques (e.g., methods) may be performed, in accordance with one or more embodiments of the disclosure.

### DETAILED DESCRIPTION

Example embodiments described herein provide certain systems, methods, and devices, for providing long-range low-power (LRLP) operation between Wi-Fi devices in various Wi-Fi networks, including, but not limited to, IEEE 802.11ax (referred to as HE or HEW), IoT device in narrow band frequencies.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

During communication between two devices, one or more frames may be sent and received on a communication channel. These frames may include one or more fields (or symbols) that may be based on IEEE 802.11 standards. The one or more fields may be sent using a frequency band of the communications channel. In Wi-Fi standards, specifically in the 2.4 and 5 GHz bands, no mode exists for devices to communicate using narrow band transmitters or receivers. Narrow band being any bandwidth less than 20 MHz. In current Wi-Fi, even for IEEE 802.11ax, devices must be able to transmit and receive at least 20 MHz or even larger than 20 MHz.

Example embodiments of the present disclosure relate to systems, methods, and devices for and LRLP system.

In one embodiment, transmitter architecture may enable LRLP operations. One of the objectives of IEEE is to enable improved low power operation for Wi-Fi devices, in addition to potentially extending the range of operation for those devices, while targeting operation in the 2.4 and 5 GHz frequency bands. An LRLP system may allow coexistence between Wi-Fi devices (e.g., legacy IEEE 802.11 or IEEE 802.11ax devices) and LRLP devices such as IoT devices. In one embodiment, an LRLP system may facilitate a transmitter design that assumes data transmissions are only between LPLR devices. In another embodiment, an LRLP system may facilitate another transmitter design to allow coexistence of LPLR devices along with Wi-Fi devices, such as IEEE 802.11 devices operating with OFDMA. An LRLP system may enable operation with a bandwidth smaller than 20 MHz. In one embodiment, physical layer (PHY) transmitter architecture may be implemented to address the above outlined requirements. The LRLP system may utilize an LRLP waveform, which may be a single carrier waveform. The LRLP waveform may be used on user data that may be processed and transmitted to other devices.

In one embodiment, the transmitter may select the LRLP waveform based on a desired transmit bandwidth (e.g., any bandwidth less than 20 MHz). Once selected, the LRLP waveform may be filtered to band-limit to the target bandwidth (and any spectral mask per user requirement). It is understood that a spectral mask is a mathematically defined set of lines applied to the levels of radio transmissions. The spectral mask is generally intended to reduce adjacent-channel interference by limiting excessive radiation at frequencies beyond the necessary bandwidth. The filtered LRLP waveform may then pass through a discrete Fourier transform (DFT). A DFT converts discrete-time data sets into a discrete-frequency representation. After passing through the DFT, the LRLP waveform may be provided to an OFDMA transmitter responsible for creating an OFDMA packet for transmission on the communications channel to a receiving device. The LRLP waveform may occupy one or more resource allocations in the OFDMA packet. It is understood that any bandwidth may be used, and the LRLP system is not limited to a minimum of 26 sub-carrier resource allocations and may utilize larger resource allocations. For example, in IEEE 802.11ax, various resource unit sizes (e.g., in subcarrier count sizes of 26, 52, 106, 242, etc. . . . , where there are 256 subcarriers in 20 MHz). The LRLP device may choose any of these sizes to enable transmission at different bandwidths.

The number of active sub-carriers populated by the LRLP waveform may depend on the selected bandwidth (e.g., any bandwidth less than 20 MHz). The approach may allow for multiple guard sub-carriers (within the assigned resource unit allocation size) in order to allow simple receiver design in LPLR receivers. Guard sub-carriers may be placed at the lower and upper part of the spectrum around the useable data bandwidth to protect against inter-channel interference (ICI) with the adjacent lower channel.

Example embodiments of the invention will now be described with reference to the accompanying figures.

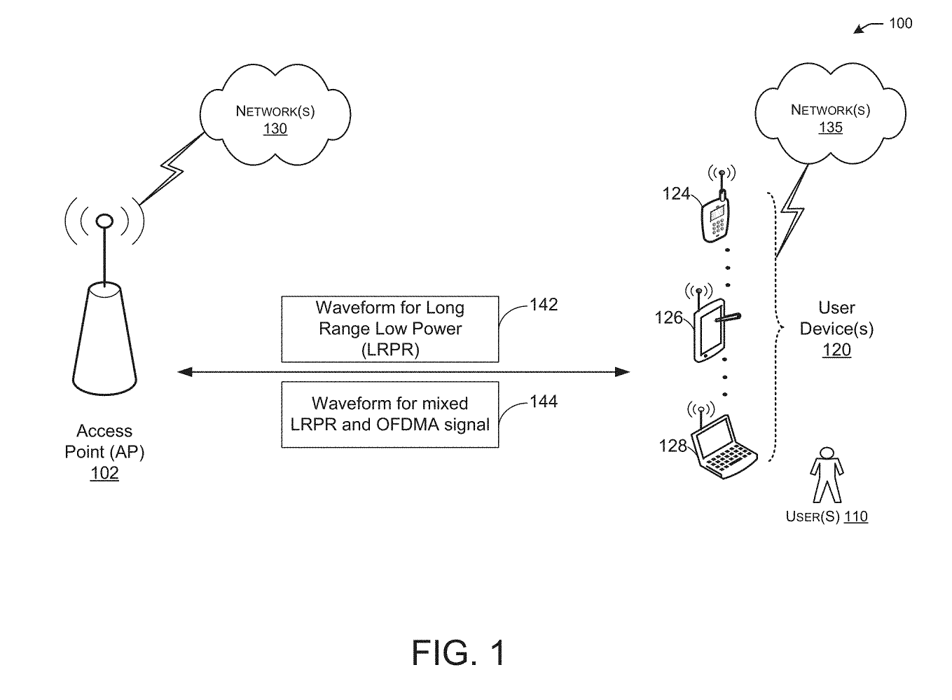

FIG. 1 is a network diagram illustrating an example network environment, according to some example embodiments of the present disclosure. Wireless network 100 may include one or more user devices 120 and one or more access point(s) (AP) 102, which may communicate in accordance with communications standards, including IEEE 802.11ax and/or using LRLP communications utilizing narrow band frequencies. The user device(s) 120 may be mobile devices that are non-stationary and do not have fixed locations. The user devices 120 may be LRLP devices, for example, IoT devices. The user devices 120 may also be devices with dual functionality for LRLP communications and other IEEE 802.11 communications (e.g., IEEE 802.11ax or legacy devices).

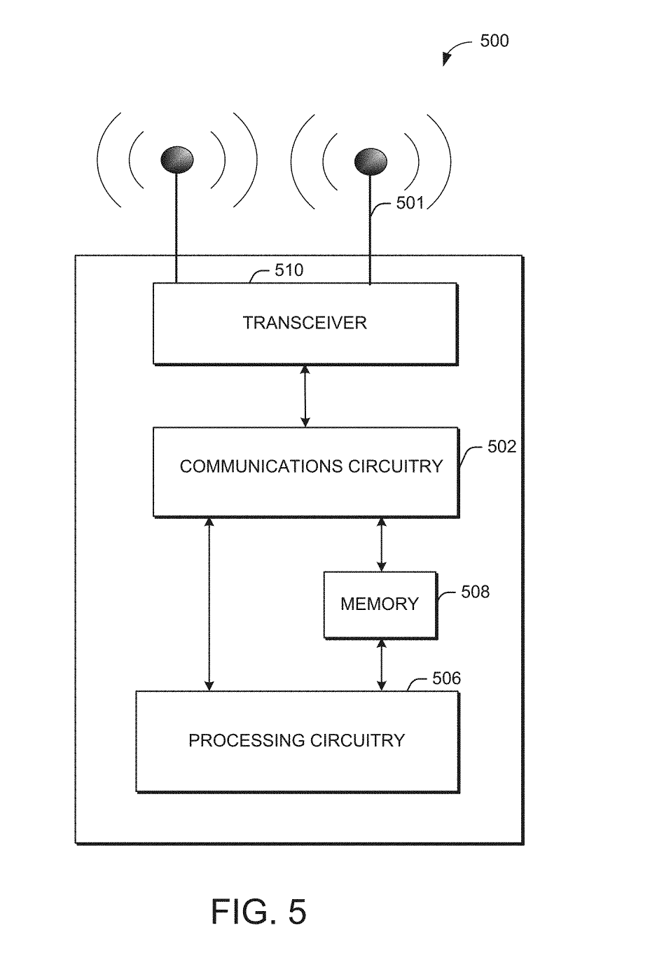

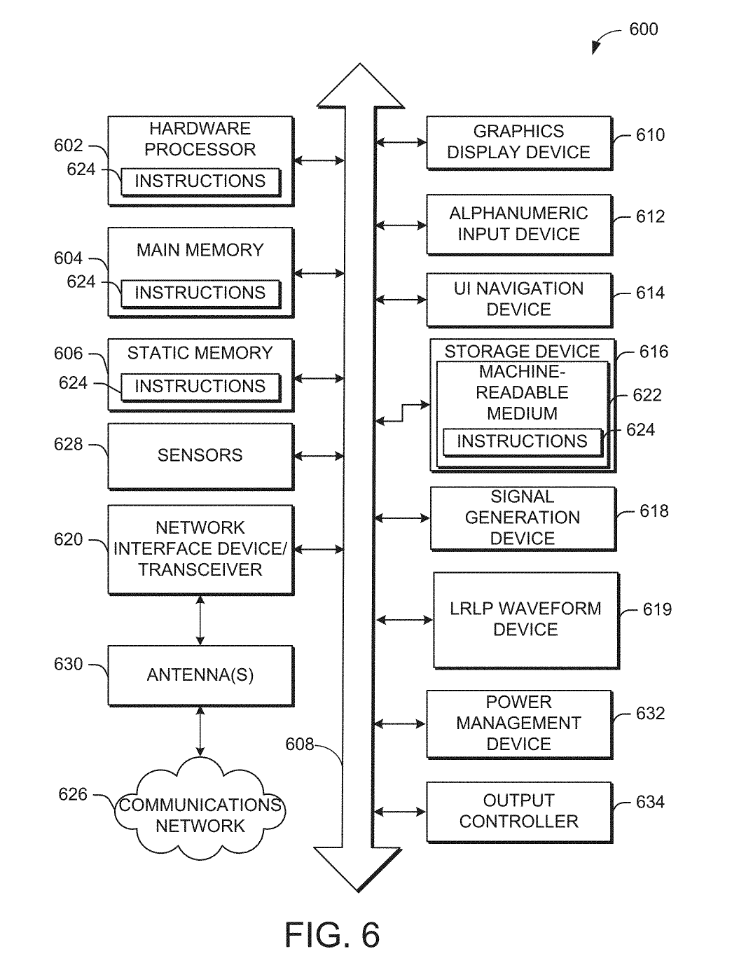

In some embodiments, the user devices 120 and AP 102 may include one or more computer systems similar to that of the functional diagram of FIG. 5 and/or the example machine/system of FIG. 6.

One or more illustrative user device(s) 120 may be operable by one or more user(s) 110. The user device(s) 120 (e.g., 124, 126, or 128) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth. The user device(s) 120 may also include IoT devices such as, home automation devices, home security devices, sensors, home monitoring and control devices, or the like.

Any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 124 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment and with reference to FIG. 1, during communication between two or more devices, for example, between an AP 102 and a user device 120, an LRLP waveform (e.g., LRLP waveforms 142 and 144) may be generated and used between the two or more devices. The LRLP waveform may allow communications in narrow band frequencies (e.g., lower than 20 MHz). For example, there may be two variations for the LRLP waveform based on the devices involved in the communication. In case the communication is between LRLP devices (e.g., IoT devices), LRLP waveform 142 may be utilized. For example, an IoT client or group of clients may be associated with an IoT Gateway (which may include an AP). In that case, communications may be done based on the LRLP waveform 142 and the AP is not connected to any Wi-Fi Clients.

In another example, in case the communication is between LRLP devices and other Wi-Fi devices (e.g., IEEE 802.11 devices), a mixed LRLP waveform 144 may be generated and used. The mixed LRLP waveform 144 may allow coexistence of LRLP devices and Wi-Fi devices while operating in narrow band frequencies.

In one embodiment, an LRLP system may have two components, one having a transmitter design that assumes the transmission may be limited to LPLR devices, and the second may allow for a mix of LPLR devices along with IEEE 802.11ax devices, or other IEEE 2011 legacy devices operating with OFDMA. The LRLP system may generate a single carrier waveform for the LPLR devices to simplify device design and cost while allowing minimal change in the legacy OFDMA architecture at the AP. The LRLP device may communicate using a single carrier waveform in one direction of the communication, for example, in the uplink direction or the downlink direction. In another example, if the LRLP waveform is used in the uplink direction, OFDM (or OFDMA) may be used in the downlink direction. Alternatively, if the LRLP waveform is used in the downlink direction, OFDM (or OFDMA) may be used in the uplink direction. The LRLP waveform may be created as a single carrier waveform, with any bandwidth value less than 20 MHz. A transmitter associated with the LRLP may select the LRLP waveform based on a target transmit bandwidth. Once selected, the LRLP waveform may be filtered by a band-limiting filter to the target bandwidth (and any spectral mask per user requirement). The LRLP waveform may then pass through a DFT. At that point, the LRLP waveform may be provided to an OFDMA transmitter to create an OFDMA packet. The LRLP waveform use one or more resource allocation in the OFDMA packet for transmission to the receiving device (e.g., AP 102 and/or user device(s) 120). For the LPLR waveform, the number of active sub-carriers populated will depend on the selected bandwidth. That is the LRLP waveform may utilize a lower number of a resource unit. For example, in a 26 sub-carriers allocation, the LRLP waveform may use 20 sub-carriers, or in a 52 sub-carriers allocation, the LRLP waveform may use 45 sub-carriers. The approach allows for multiple guard sub-carriers in order to allow simple receiver designs in the LPLR receivers.

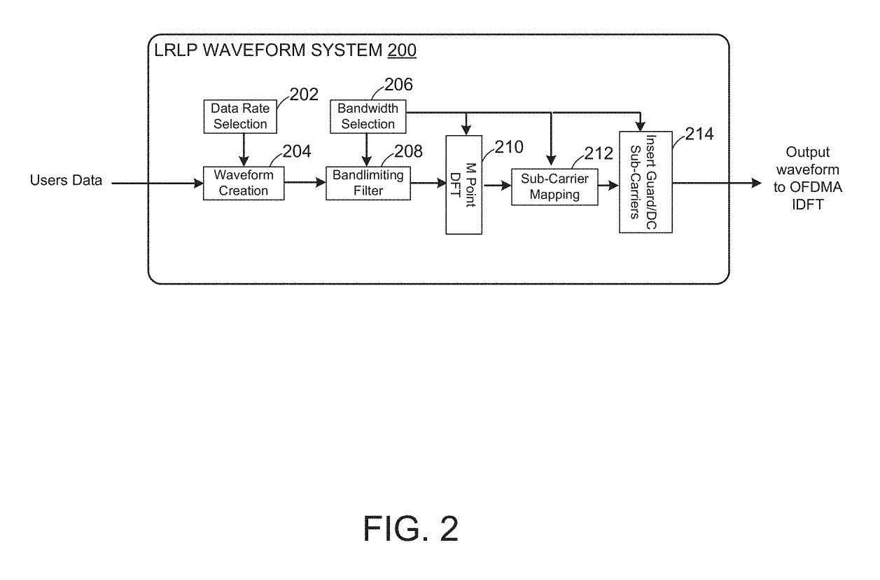

FIG. 2 depicts an illustrative schematic diagram of an LRLP waveform system 200, in accordance with one or more example embodiments of the present disclosure.

In one embodiment, an LRLP waveform system may include PHY architecture to enable narrow band transmission and reception within the 2.4 and 5 GHz band. One aspect of the PHY architecture may include a transmitter design that assumes the transmission is limited to LPLR devices.

In one embodiment, the transmitter of the LRLP waveform system 200 may include one or more functional block for generating an LRLP waveform. The transmitter may include a data rate selection 202 block, a waveform creation 204 block, a bandwidth selection 206 block, a bandlimiting filter 208 block, an M-Point DFT 210 block, a sub-carrier mapping 212 block, and a guar/DC sub-carriers 214 block.

The LRLP waveform may operate on incoming data (e.g., user data and/or MAC data), after passing through the traditional blocks found in the IEEE 802.11 a/g/n/ac/ax systems. These traditional blocks may include at least in part, a scrambler, a forward error correction (FEC) (using binary convolution codes (BCC) or density parity-check (LDPC) encoders), channel interleaver, constellation mapping, or other blocks necessary for signal processing. It is understood that no strict requirements on how the user data is encoded, scrambled or interleaved. The example of FIG. 2 shows the user data after it has been encoded, scrambled, or interleaved.

The encoded user data may be passed to the waveform creation 204 block. The LRLP waveform may be selected using the data rate selection 202 and waveform creation 204 blocks, based on the desired transmit bandwidth, which is determined by the bandwidth selection 206 block. It is understood that the details of the waveform are not specified at this point, and do not create a limitation to this embodiment.

Once selected, the waveform is filtered using the bandlimiting filter 208 block in order to band-limit the waveform to the target bandwidth (and any spectral mask per user requirement). It should be noted that the band-limiting filter block is not a mandatory block and that after the waveform is created, it may be passed through the M-Point DFT 210 block instead of going through the bandlimiting filter 208 block. It is understood that the M value is the number of frequency samples for the DFT. The size of the M-Point DFT 210 used may be based on the selected waveform and the target bandwidth (e.g., based on the bandwidth selection 206 block).

In one embodiment, the waveform could use some or all of the blocks of the transmitter of the LRLP waveform system 200 or may introduce other blocks. The output of the M-Point DFT 210 block may be sent to the sub-carrier mapping 212 block. This block may then populate the sub-carriers that should be active based on the bandwidth selection and the resource allocation selected. Additionally, the sub-carrier mapping 212 block may be used to map the LRLP waveform to a resource allocation within the OFDMA structure of Wi-Fi standards. In that context, not all the resource blocks have the same mapping for guard sub-carriers or for the direct conversion (DC) sub-carrier. The LRLP waveform may then be provided to an OFDM transmitter, which may create an OFDMA packet to be transmitted to a receiving device.

The insert guard/DC sub-carrier 214 block may process the LRLP waveform following the sub-carrier mapping 212 block. The insert guard/DC sub-carrier 214 block may be used to zero out sub-carriers above any bandwidth based on the bandwidth selection block. Additionally, the insert guard/DC sub-carrier 214 may allow for the option of zeroing DC, and possibly around DC. It should be understood that the insert guard/DC sub-carrier 214 block may be optional and may be used based on which resource allocation is utilized.

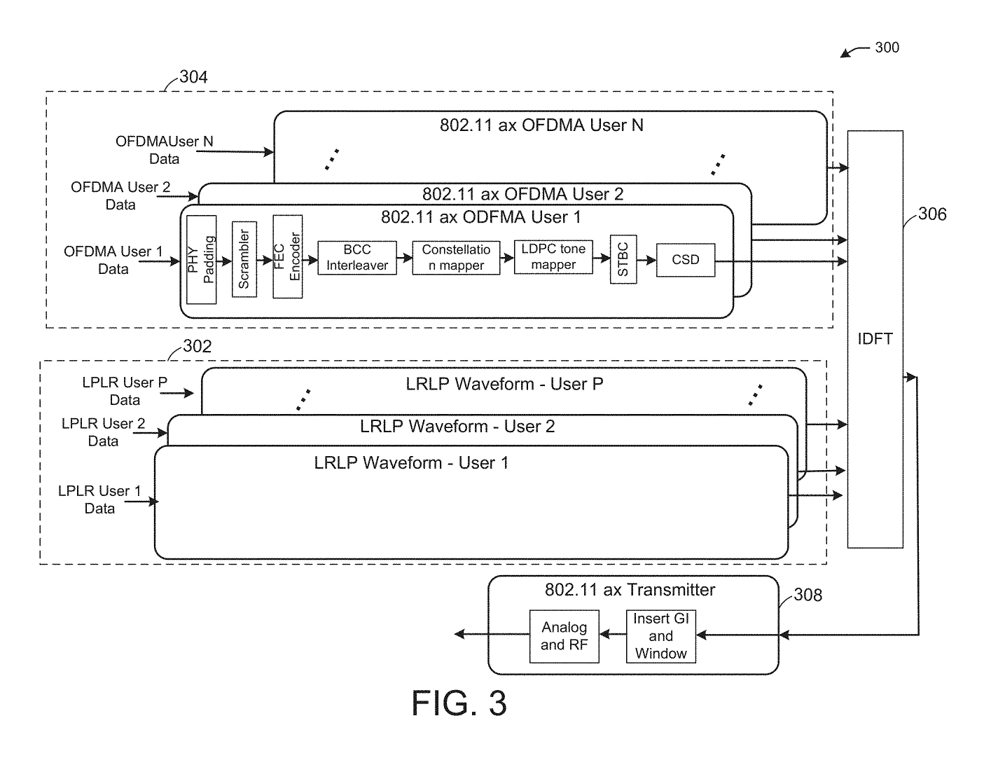

FIG. 3 depicts an illustrative schematic diagram of an HEW frame with multiple subchannels, in accordance with one or more example embodiments of the present disclosure.

In one embodiment, the LRLP system may integrate the LRLP waveform within IEEE 802.11ax devices, or other IEEE 2011 legacy devices operating with OFDMA. FIG. 3 shows a transmitter architecture 300 of such integration, where both LRLP waveform system 302 and IEEE 802.11ax OFDMA system 304 coexist. It should be noted that although IEEE 802.11ax is shown in the transmitter architecture 300, this is only for illustrative purposes and other IEEE 802.11 OFDMA systems may be used instead (e.g., IEEE 802.11 a/g/n/ac, etc.).

In FIG. 3, the IEEE 802.11ax OFDMA system 304 may include defined 802.11ax OFDMA user blocks. The LRLP waveform system 302 may include user parts 1 through P for generating the LRLP waveform on a per user basis, where P is an integer. The IEEE 802.11ax OFDMA system 304 may include user parts 1 through N for processing IEEE 802.11ax signals on a per user basis, where N is an integer.

The LRLP waveform system 302 and the IEEE 802.11ax OFDMA system 304 may have one or more blocks in common. For example, they both may include a PHY padding, a scrambler, an FEC encoder, and a BCC interleaver.

In one embodiment, following the one or common blocks, the LPLR waveform system 302 may operate on the LRLP waveform as described in the FIG. 2 discussion.

It should be understood that the various blocks described in FIG. 3 may vary based on requirements and implementations. For example, the input signals (e.g., LRLP user data and the OFDMA user data) into the LRLP waveform system 302 and the IEEE 802.11ax OFDMA system 304 may use blocks based on IEEE 802.11, or may use a subset, or additional blocks.

In one embodiment, the output signals from the IEEE 802.11ax OFDMA system 304 and the LRLP waveform system 302 may be sent to an inverse discrete Fourier transform (IDFT) 306. The DFT transforms a signal from the time domain (where each sample in the signal is associated with a time) into the frequency domain. The IDFT 306 maps the signal back from the frequency domain into the time domain. After passing through the IDFT 306, the signal is then passed through an IEEE 802.11ax transmitter 308 in order to be prepared for transmission to a receiving device (e.g., user devices 120 and/or AP 102 of FIG. 1). It is understood that although an IEEE 802.11ax transmitter is shown in FIG. 3, other IEEE 802.11 transmitters may be used (e.g., IEEE 802.11 a/g/n/ac, etc.).

It should be noted that FIG. 3 assumes that all the OFDMA users are using the same size resource allocation. This is not a restriction, but this is only for illustrative purposes. Thus, the approach is not limited to the case where all LPLR users or OFDMA users are allocated the same resource allocation size. Additionally, to simplify FIG. 3 and the discussion, a single stream case is shown. Again, the design is not limited to a single stream. For the purposes of discussion, it is assumed that the minimum resource allocation (26 sub-carriers) is used. Likewise, the LPLR users also use the minimum resource allocation. However, other resource allocation may be utilized. The transmitter architecture 300 may enable LRLP devices, such as IoT devices, to communicate using an LRLP waveform that may be in the form of a single carrier with other LRLP devices and/or other IEEE 802.11 devices operating with OFDMA. The LRLP devices may communicate using a single carrier waveform in one direction of the communication, for example, in the uplink direction or the downlink direction. In another example, if the LRLP waveform is used in the uplink direction, OFDM (or OFDMA) may be used in the downlink direction. Alternatively, if the LRLP waveform is used in the downlink direction, OFDM (or OFDMA) may be used in the uplink direction.

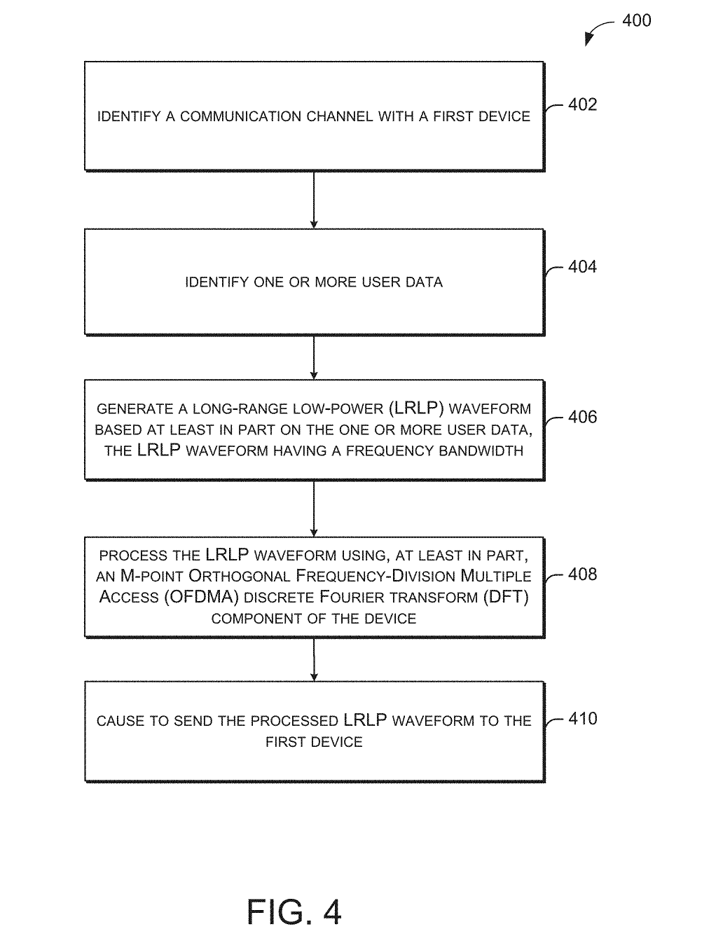

FIG. 4 illustrates a flow diagram of illustrative process 400 for a high efficiency signal field coding system in accordance with one or more embodiments of the disclosure.

At block 402, one or more devices (e.g., AP 102 or user device(s) 120 of FIG. 1) may communicate with each other using a communication channel. The one or more devices may be LRLP devices (e.g., IoT devices) and/or IEEE 802.11 devices. For example, an AP may be in communication with one or more IEEE 802.11 devices (e.g., laptops, tablets, phones), and/or in communication with IoT devices (e.g., home automation devices, home security, sensors, etc.).

At block 404, the device may identify one or more user data that may be prepared for transmission from to a receiving device. For example, the AP may prepare one or more user data for transmission to one or more user devices 120 (FIG. 1). The AP may include an LRLP waveform system and/or IEEE 802.11ax OFDMA system. In the case where the AP is communicating only with LRLP devices, the AP may utilize the LRLP waveform system to prepare the user data for transmission. However, if the AP is communicating with IEEE 802.11 devices as well, the AP may integrate the LRLP waveform with the IEEE 802.11 data. The LRLP waveform may be a single carrier waveform. The LRLP device may communicate using a single carrier waveform in one direction of the communication, for example, in the uplink direction or the downlink direction. In another example, if the LRLP waveform is used in the uplink direction, OFDM (or OFDMA) may be used in the downlink direction. Alternatively, if the LRLP waveform is used in the downlink direction, OFDM (or OFDMA) may be used in the uplink direction. The single carrier may be carried using bandwidth that may be less than 20 MHz.

At block 406, the device may generate an LRLP waveform based at least in part on the one or more user data, the LRLP waveform having a frequency bandwidth.

At block 408, the device may pass the LRLP waveform through, at least in part, an M-point discrete Fourier transform (DFT) component of the device. The LRLP waveform maybe prepared by a series of components, such as a data rate selection component, a waveform creation component, a bandwidth selection b component, a bandlimiting filter component, an M-Point DFT component, a sub-carrier mapping component, and a guar/DC sub-carriers component. The user data may be passed to the waveform creating component. The LRLP waveform may be selected using the data rate selection and waveform creation component, based on the desired transmit bandwidth, which is determined by the bandwidth selection component. It is understood that the details of the waveform are not specified at this point, and do not create a limitation to this design. Once selected, the LRLP waveform may be filtered using the bandlimiting filter component in order to band-limit the waveform to the target bandwidth.

At block 410, the device may send the processed LRLP waveform to the receiving device(s). The LRLP waveform may occupy one or more resource allocations in the OFDMA packet.

FIG. 5 shows a functional diagram of an exemplary communication station 500 in accordance with some embodiments. In one embodiment, FIG. 5 illustrates a functional block diagram of a communication station that may be suitable for use as an AP 102 (FIG. 1) or user device 120 (FIG. 1) in accordance with some embodiments. The communication station 500 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, home automation devices, home security, sensors, home monitoring and control devices, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in FIGS. 1-4.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device may, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device memory.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), an LRLP waveform device 619, a network interface device/transceiver 620 coupled to antenna(s) 630, and one or more sensors 628, such as a global positioning system (GPS) sensor, compass, accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The LRLP waveform device 619 may be carry out or perform any of the operations and processes (e.g., process 400) described and shown above. For example, the LRLP waveform device 619 may be configured to introduce a new transmitter architecture to enable Long-Range, Low-Power (LRLP) operations. The LRLP waveform device 619 may address coexistence with legacy devices or other Wi-Fi devices (e.g., IEEE 802.11ax). The LRLP waveform device 619 may facilitate a transmitter design that assumes the transmission is limited to LPLR devices. Additionally/alternatively, the LRLP waveform device 619 may allow for a mix of LPLR devices along with Wi-Fi devices, such as IEEE 802.11ax devices operating with OFDMA. The LRLP waveform device 619 may generate a single carrier waveform for LPLR devices in order to simplify the IoT device design and cost. The LRLP device may communicate using a single carrier waveform in one direction of the communication, for example, in the uplink direction or the downlink direction. In another example, if the LRLP waveform is used in the uplink direction, OFDM (or OFDMA) may be used in the downlink direction. Alternatively, if the LRLP waveform is used in the downlink direction, OFDM (or OFDMA) may be used in the uplink direction. Additionally, the designed waveform may allow legacy OFDM architecture to be reused at the AP.

The LRLP waveform device 619 may select an LRLP waveform based on the desired transmit bandwidth. Once selected, the LRLP waveform may be filtered to band-limit to the target bandwidth (and any spectral mask per user requirement). The LRLP waveform may then pass through a discrete Fourier transform (DFT). The LRLP waveform device 619 may provide the LRLP waveform to the OFDM transmit architecture, which creates an OFDMA packet for transmission. The LRLP waveform device 619 may use one or more resource allocations in the OFDMA packet to send the LRLP waveform.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

According to example embodiments of the disclosure, there may be a device. The device may include at least one memory that stores computer-executable instructions, and at least one processor of the one or more processors configured to access the at least one memory, wherein the at least one processor of the one or more processors is configured to execute the computer-executable instructions to identify one or more user data. The at least one processor of the one or more processors may be configured to execute the computer-executable instructions to generate a long-range low-power (LRLP) waveform based at least in part on the one or more user data, the LRLP waveform having a frequency bandwidth. The at least one processor of the one or more processors may be configured to execute the computer-executable instructions to pass the LRLP waveform through, at least in part, an M-point discrete Fourier transform (DFT) component of the device. The at least one processor of the one or more processors may be configured to execute the computer-executable instructions to cause to send the processed LRLP waveform to the first device.

The implementations may include one or more of the following features. A value of M is selected based at least in part on the frequency bandwidth. The computer-executable instructions to pass the LRLP waveform through an M-point DFT may further include instructions to filter the LRLP waveform using a band limiting filter. The at least one processor of the one or more processors may be configured to execute the computer-executable instructions to perform sub-carrier mapping for the LRLP waveform. The at least one processor of the one or more processors may be configured to execute the computer-executable instructions to insert one or more guard sub-carriers to the waveform. The sub-carrier mapping may populate one or more active sub-carriers of the communication channel based on the frequency bandwidth. The LRLP waveform may be a single carrier waveform. The first device is an Internet of things (IoT) device. The first device may be a Wi-Fi device in accordance with IEEE 802.11 ax. The frequency bandwidth may be less than 20 MHz. The device may include a transceiver configured to transmit and receive wireless signals. The device may include an antenna coupled to the transceiver.

According to example embodiments of the disclosure, there may be a non-transitory computer-readable medium storing computer-executable instructions which, when executed by a processor, cause the processor to perform operations. The operations may include generating a long-range low-power (LRLP) waveform based at least in part on the one or more user data, the LRLP waveform having a frequency bandwidth. The operations may include processing the LRLP waveform using, at least in part, an M-point discrete Fourier transform (DFT) component of the device. The operations may include causing to send the processed LRLP waveform to the first device.

The implementations may include one or more of the following features. A value of M may be selected based at least in part on the frequency bandwidth. The operations may further include filtering the LRLP waveform using a band limiting filter. The operations may further include performing sub-carrier mapping for the LRLP waveform. The operations may further include inserting one or more guard sub-carriers to the waveform. The sub-carrier mapping may populate one or more active sub-carriers of the communication channel based on the frequency bandwidth. The LRLP waveform may be a single carrier waveform. The first device may be an Internet of things (IoT) device. The first device may be a Wi-Fi device in accordance with IEEE 802.11 ax. The frequency bandwidth may be less than 20 MHz.

In example embodiments of the disclosure, there may be a method. The method may include identifying a communication channel with a first device. The method may include identifying one or more user data. The method may include generating a long-range low-power (LRLP) waveform based at least in part on the one or more user data, the LRLP waveform having a frequency bandwidth. The method may include processing the LRLP waveform using, at least in part, an M-point Orthogonal Frequency-Division Multiple Access (OFDMA) discrete Fourier transform (DFT) component of the device. The method may include causing to send the processed LRLP waveform to the first device.

Implementations may include one or more of the following features. A value of M may be selected based at least in part on the frequency bandwidth. Processing the LRLP waveform may further include filtering the LRLP waveform using a band limiting filter. The method may further include performing sub-carrier mapping for the LRLP waveform. The method may further include inserting one or more guard sub-carriers to the waveform. The sub-carrier mapping may populate one or more active sub-carriers of the communication channel based on the frequency bandwidth. The LRLP waveform may be a single carrier waveform. The first device may be an Internet of things (IoT) device. The first device may be a Wi-Fi device in accordance with IEEE 802.11 ax. The frequency bandwidth may be less than 20 MHz.

In example embodiments of the disclosure, there may be an apparatus. The apparatus may include means for identifying a communication channel with a first device. The apparatus may include means for identifying one or more user data. The apparatus may include means for generating a long-range low-power (LRLP) waveform based at least in part on the one or more user data, the LRLP waveform having a frequency bandwidth. The apparatus may include means for passing the LRLP waveform through, at least in part, an M-point discrete Fourier transform (DFT) component of the device. The apparatus may include means for causing to send the processed LRLP waveform to the first device.

Implementations may include one or more of the following features. A value of M is selected based at least in part on the frequency bandwidth. The apparatus may further include means for filtering the LRLP waveform using a band limiting filter. The apparatus may further include means for performing sub-carrier mapping for the LRLP waveform. The apparatus may further include means for concerning one or more guard sub-carriers to the waveform. The sub-carrier mapping may populate one or more active sub-carriers of the communication channel based on the frequency bandwidth. The LRLP waveform is a single carrier waveform. The first device is an Internet of things (IoT) device. The first device is a Wi-Fi device in accordance with IEEE 802.11 ax. The frequency bandwidth is less than 20 MHz.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor configured to access the at least one memory, wherein the at least one processor is configured to execute the computer-executable instructions to:
identify a communication channel with a first device;
identify one or more user data;
generate a long-range low-power (LRLP) waveform based at least in part on the one or more user data, the LRLP waveform having a frequency bandwidth;
pass the LRLP waveform through, at least in part, an M-point discrete Fourier transform (DFT) component of the device; and
cause to send the processed LRLP waveform to the first device.

2. The device of claim 1, wherein a value of M is selected based at least in part on the frequency bandwidth.

3. The device of claim 2, wherein the computer-executable instructions to pass the LRLP waveform through an M-point DFT further includes instructions to:
filter the LRLP waveform using a band limiting filter;
perform sub-carrier mapping for the LRLP waveform; and
insert one or more guard sub-carriers into the waveform.

4. The device of claim 3, wherein the sub-carrier mapping populates one or more active sub-carriers of the communication channel based on the frequency bandwidth.

5. The device of claim 1, wherein the LRLP waveform is a single carrier waveform.

6. The device of claim 1, wherein the first device is an Internet of things (IoT) device.

7. The device of claim 1, wherein the first device is a Wi-Fi device in accordance with IEEE 802.11 ax.

8. The device of claim 1, wherein the frequency bandwidth is less than 20 MHz.

9. The device of claim 1, further comprising a transceiver configured to transmit and receive wireless signals.

10. The device of claim 9, further comprising an antenna coupled to the transceiver.

11. A non-transitory computer-readable medium storing computer-executable instructions which when executed by one or more processors result in performing operations comprising:
identifying a communication channel with a first device;
identifying one or more user data;
generating a long-range low-power (LRLP) waveform based at least in part on the one or more user data, the LRLP waveform having a frequency bandwidth;
passing the LRLP waveform through, at least in part, an M-point discrete Fourier transform (DFT) component of the device; and
causing to send the processed LRLP waveform to the first device.

12. The non-transitory computer-readable medium of claim 11, wherein a value of M is selected based at least in part on the frequency bandwidth.

13. The non-transitory computer-readable medium of claim 12, wherein the computer-executable instructions cause the processor to further perform operations comprising:
filtering the LRLP waveform using a band limiting filter;
performing sub-carrier mapping for the LRLP waveform; and
concerning one or more guard sub-carriers to the waveform.

14. The non-transitory computer-readable medium of claim 13, wherein the sub-carrier mapping populates one or more active sub-carriers of the communication channel based on the frequency bandwidth.

15. The device of claim 1, wherein the LRLP waveform is a single carrier waveform.

16. The non-transitory computer-readable medium of claim 11, wherein the first device is an Internet of things (IoT) device.

17. The non-transitory computer-readable medium of claim 11, wherein the first device is a Wi-Fi device in accordance with IEEE 802.11 ax.

18. The non-transitory computer-readable medium of claim 11, wherein the frequency bandwidth is less than 20 MHz.

19. A method comprising:
identifying a communication channel with a first device;
identifying one or more user data;
generating a long-range low-power (LRLP) waveform based at least in part on the one or more user data, the LRLP waveform having a frequency bandwidth;
pass the LRLP waveform through, at least in part, an M-point discrete Fourier transform (DFT) component of the device; and
causing to send the processed LRLP waveform to the first device.

20. The method of claim 19, wherein the LRLP waveform is a single carrier waveform.
